(19) United States
(12) Patent Application Publication
(10) Pub. No.: US 2011/0195159 A1
(43) Pub. Date: Aug. 11, 2011

(54) METHODS AND SYSTEMS FOR MAKING CO-EXTRUDED FOOD PRODUCTS

(75) Inventors: Jay David Parker, Park City, KS (US); Phillip J. Rincker, Wichita, KS (US); Brock Aaron Zentz, Andover, KS (US)

(73) Assignee: CARGILL, INCORPORATED, Wayzata, MN (US)

(21) Appl. No.: 13/123,449

(22) PCT Filed: Oct. 8, 2009
(86) PCT No.: PCT/US09/59986

§ 371 Date: Apr. 8, 2011

Related U.S. Application Data
(60) Provisional application No. 61/195,582, filed on Oct. 8, 2008.

(51) Int. Cl. A23P 1/12; A47J 43/20; A23L 1/00

(52) U.S. Cl. 426/89; 99/450.1; 426/512

(57) ABSTRACT

Described is a system and a method for making a co-extruded food product. The system is for continuously making individual co-extruded food products and may comprise: a food supply system comprising a first extrudable food supply and a second extrudable food supply that are horizontally co-extruded at a predetermined extrusion rate into a substantially linear stream of coextrudate comprising a substantially continuous layer of the first food supply surrounding a substantially continuous layer of the second food supply; and a cutting system, comprising a cutting element for cutting the stream of coextrudate supplied by the food supply system, wherein the timing of movement of the cutting element is synchronized with the extrusion rate to provide individual co-extruded food products having an approximately predetermined size and weight.

### CROSS REFERENCE TO RELATED APPLICATION

This application claims the benefit of U.S. provisional application Ser. No. 61/195,582 filed Oct. 8, 2008 entitled METHODS AND SYSTEMS FOR MAKING CO-EXTRUDED FOOD PRODUCTS, which is hereby incorporated by reference in its entirety.

### FIELD OF THE INVENTION

This invention relates to methods of making meat products. Particularly, the invention relates to methods and systems for making co-extruded food products, and even more particularly for making co-extruded, filled meat products.

### BACKGROUND

Before automation, consumers generally formed food product in the form of patties by hand. Demand for high-speed and high-volume production of such food products led to the development of automated machines configured to provide such food products.

Generally, in such automated machines, a supply hopper feeds raw meat into a food pump that pumps the meat. The meat is either pumped into a mold cavity of a mold plate or is pumped and crimped or cut at certain intervals in order to form patties. A typical application for such automated machines is in the production of hamburger patties.

In some cases, formed food products or patties are desired to have fillings. In one such example, the meat and a filling are co-extruded with the filling, e.g., cheese, being pumped in pulses through a tube that is surrounded by a continuous, vertical flow of meat. The meat is then crimped to enclose the cheese within the meat. A drawback to using such a vertically-filling and crimping method is that the rate of production is low. Another drawback is that there are several moving parts used to crimp the meat that are subject to wear-and-tear. Furthermore, the method relies upon the timing of the machine to ensure the proper amount of cheese in the resulting food product. Only approximately 60-100 food products, or patties, per minute can be made using such a method.

Despite the existing machines and methods for producing filled food products, in the form of patties, for example, there is still a demand for improved high volume, high-speed machinery and methods for making such food products.

### SUMMARY OF THE INVENTION

The invention involves a system and method for making co-extruded food products, and in particular meat patties filled with a filler material, such as cheese. There are advantages of this invention over existing methods and systems. The invention preferably includes a horizontal co-extrusion process of meat and filler, which continuously supplies a substantially linear stream of coextrudate. Thus, there is no need to pulse the filler, nor to rely on timing of the machine, in order to obtain a desired amount of filler in each food product. Another advantage of the invention is a substantially continuous linear stream of coextrudate results from the horizontal co-extrusion process, which contributes to the formation of more uniform food products cut from the stream of coextrudate.

The invention uses a cutting system to cut the linear stream of coextrudate and produce individual food products, which eliminates the use of a crimper, as in prior devices. This reduces the number of parts subject to repair or replacement, because only a blade and a motor are preferably used. Also, cutting the coextrudate is quicker than the crimping process, which allows for a higher volume of food product to be produced. Approximately 150-250 food products, or patties, may be produced per minute using the invention.

A first aspect of the invention is a system for continuously making individual co-extruded food products comprising: a food supply system comprising a first extrudable food supply and a second extrudable food supply that are horizontally co-extruded at a predetermined extrusion rate into a substantially linear stream of coextrudate comprising a substantially continuous layer of the first extrudable food supply surrounding a substantially continuous layer of the second extrudable food supply; and a cutting system, comprising a cutting element for cutting the stream of coextrudate supplied by the food supply system, wherein the timing of movement of the cutting element is synchronized with the extrusion rate to provide individual co-extruded food products having an approximately predetermined size and weight. The system may further comprise a flattening system adjacent the cutting system and for advancing and flattening the individual co-extruded food products, and comprising a first and a second conveyor converging toward each other to define a gap between them tapering from a wider gap end to a narrower gap end for progressively flattening the individual co-extruded food products. The system may further comprise a cooling system. The cutting element may be a rotatable blade comprising at least one cutting surface for cutting the stream of coextrudate. The cutting element may be a guillotine-type blade. The system may further comprise a packaging system for packaging the individual co-extruded food products. The cutting system may cut the linear stream of coextrudate approximately transverse to the linear stream. The transverse cuts used to form each individual co-extruded food product may expose the second extrudable supply layer. The first extrudable food supply may comprise a meat. The second extrudable food supply may comprise a material selected from the group consisting of a cheese, a sauce, a meat slurry, and a fruit filling. The second extrudable food supply may be pumpable at a temperature necessary for safe storage and production of refrigerated food products, which may be about 40 degrees F. or below. The second extrudable food supply may have a viscosity and a melting point such that when cooking the food products, the second extrudable food supply layer is not flowable, which may be above about 180 degrees F. The system may comprise a cooling system that maintains a temperature of about 50 degrees F. or below.

A second aspect of the invention is a method of making individual co-extruded food products in a continuous process comprising the steps of: providing a first extrudable supply of food and a second extrudable supply of food; continuously horizontally co-extruding the supplies of food at a predetermined extrusion rate wherein the first supply is substantially continuous and substantially surrounds the second supply that is substantially continuous, such that a substantially linear stream of coextrudate is formed; and cutting the stream of coextrudate into individual co-extruded food products wherein the timing of the cutting is synchronized with the extrusion rate to provide individual co-extruded food products having an approximately predetermined size and weight. The method may further comprise flattening the individual co-extruded food products after the cutting step. The flattening step may comprise advancing the individual co-extruded food products between a first conveyor and a second conveyor converging toward each other to define a gap tapering from a wider gap end to a narrower gap end for progressively flattening the individual co-extruded food products. The cut made during the cutting step may be approximately transverse to the linear stream of coextrudate. The transverse cuts used to form each individual co-extruded food product may expose the second supply. The method may further comprise a step of cooling the individual co-extruded food products after the cutting step. The cutting step may comprise cutting the coextrudate with a rotatable blade comprising at least one cutting surface. The cutting step may comprise cutting the coextrudate with a guillotine-type blade. The method may further comprise a step of packaging the individual co-extruded food products after the cutting step. The first extrudable food supply may comprise a meat. The second extrudable food supply may comprise a material selected from the group consisting of a cheese, a sauce, a meat slurry, and a fruit filling. The second extrudable food supply may be pumpable at a temperature necessary for safe storage and production of refrigerated food products, which may be about 40 degrees F. or below. The second extrudable food supply may have a viscosity and a melting point such that when cooking the food products, the second extrudable food supply layer is not flowable, which may be above about 180 degrees F. The cooling step may include cooling to a temperature of about 50 degrees F. or below.

A third aspect of the invention is a co-extruded food product. The co-extruded food product may be made by the method described above. The co-extruded food product cut from a substantially continuous linear stream of coextrudate may comprise: a substantially continuous layer of a first food product; and a layer of a second food product that at least partially surrounds the layer of the first food product; wherein the co-extruded food product is cut transverse to the linear stream of coextrudate such that the layer of the first food product is exposed on opposing ends. The co-extruded food product may have square or rectangular shape. The first layer may be exposed along two opposing sides of the food product. The second layer may surround the first layer except at or near where the coextrudate is cut. The first layer may comprise a material selected from the group consisting of a cheese, a sauce, a meat slurry, and a fruit filling. The second layer may comprise a meat. The first layer material may be pumpable at a temperature necessary for safe storage and production of refrigerated food products, which may be about 40 degrees F. or below. The first layer material may have a viscosity and a melting point such that when cooking the food products, the first layer is not flowable, which may be above about 180 degrees F.

A fourth aspect of the invention is a system for continuously making individual co-extruded food products comprising: a means for supplying a first extrudable food supply and a second extrudable food supply; a means for horizontally co-extruding the first and second supplies at a predetermined extrusion rate into a substantially linear stream of coextrudate comprising a substantially continuous layer of the first food supply surrounding a substantially continuous layer of the second food supply; and a means for cutting the stream of coextrudate supplied by the food supply system, wherein the timing of movement of the cutting means is synchronized with the extrusion rate to provide individual co-extruded food products having an approximately predetermined size and weight. The system may further comprise a means for flattening the individual co-extruded food products. The system may further comprise a means for cooling the individual co-extruded food products. The system may further comprise a means for packaging the individual co-extruded food products. The first extrudable food supply may comprise a meat. The second extrudable food supply may comprise a material selected from the group consisting of a cheese, a sauce, a meat slurry, and a fruit filling. The second extrudable food supply may be pumpable at a temperature necessary for safe storage and production of refrigerated food products, which may be about 40 degrees F. or below. The second extrudable food supply may have a viscosity and a melting point such that when cooking the food products, the second extrudable food supply layer is not flowable, which may be above about 180 degrees F. The cooling means may maintain a temperature of about 50 degrees F. or below.

### BRIEF DESCRIPTION OF THE DRAWINGS

The above-mentioned and other advantages of the invention, and the manner of attaining them, will become apparent and the invention itself will be better understood by reference to the following description of the embodiments of the invention taken in conjunction with the accompanying drawings, wherein like structure is referred to by like numerals throughout the figures, and wherein:

FIG. 1 is an illustration of an exemplary system in accordance with the invention;

FIG. 2 is a close-up, cross-sectional illustration of a portion of the system in accordance with the invention; and

FIG. 3 is an illustration of a food product in accordance with the invention.

### DETAILED DESCRIPTION OF THE INVENTION

With reference to the accompanying figures, wherein like components are labeled with like numerals throughout the figures, an illustrative system and food product are shown.

The embodiments of the invention shown in the figures and described below are not intended to be exhaustive or to limit the invention to the precise forms shown and disclosed in the following detailed description. Rather a purpose of the embodiments chosen and described is so that the appreciation and understanding by others skilled in the art of the principles and practices of the invention can be facilitated.

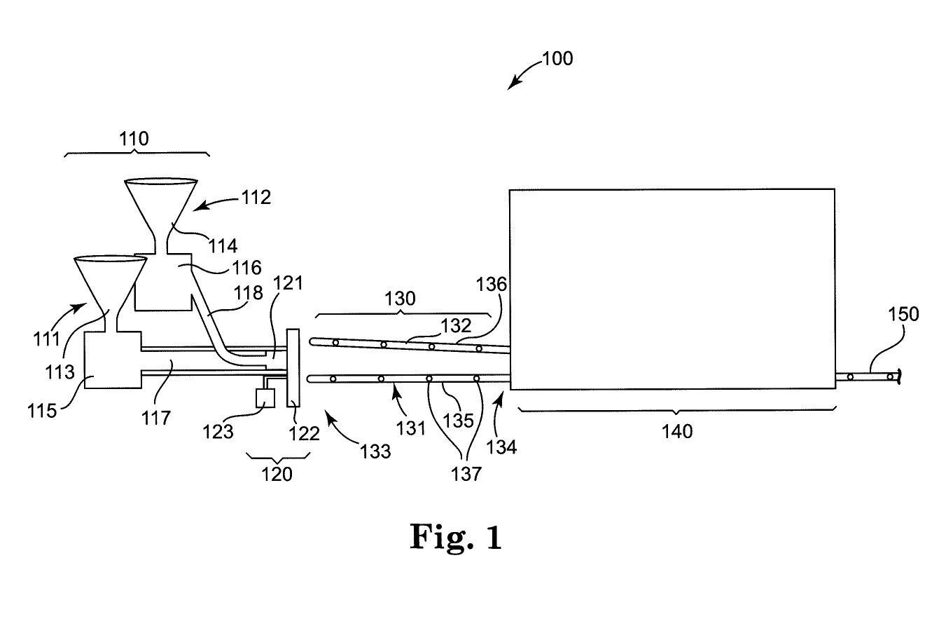

FIG. 1 illustrates a first aspect of the invention, which is an exemplary system for continuously making individual co-extruded food products. The purpose of the system is to form and process co-extruded food products, e.g., patties of meat and cheese, preferably, at high-speed. The overall system 100 includes a food supply system 110, a cutting system 120, a flattening system 130, a cooling system 140 and a further processing (e.g., packaging) system (not shown, but beginning at 150). It is contemplated that the systems included in the overall system 100 may be housed in one or more machine bases (not shown) that would serve to support and/or house the systems. It is also contemplated that the overall system may include additional systems, fewer systems, or alternative systems from those depicted in FIG. 1 and described herein.

In FIG. 1, a food supply system 110 is shown. The food supply system 110 preferably includes a first extrudable food supply 111 (e.g., meat) and a second extrudable food supply 112 (e.g., cheese). The first extrudable food supply 111 preferably comprises a hopper 113 and a food pump 115, while the second extrudable food supply 112 similarly preferably comprises a hopper 114 and a food pump 116. In operation of the system 100, the first and second extrudable food supplies are deposited into their respective hoppers 113, 114. The hoppers 113, 114 then provide the food supplies to the food pumps 115, 116, which propel the supplies forward in the system 100. Preferably, the supplies are pumped in a manner and at a rate such that the consistency of the food supplies are not negatively affect.

Next, in the food supply system 110, the food supplies are preferably co-extruded from the pumps 115, 116 through a first supply tube 117 and a second supply tube 118, respectively. The first supply tube 117 is shown preferably extending horizontally from the pump 115. The second supply tube 118 is preferably shown extending into the first supply tube 117 such that second supply pumped through the tube 118 is preferably entirely surrounded by first supply pumped through the first supply tube 117. A continuous web or linear stream of first (e.g., meat) and second (e.g., cheese) extrudable food supplies preferably results from the coextrusion, and preferably comprising an outer layer or web of meat, for example, that completely surrounds a continuous inner layer or web of cheese, for example.

The co-extruding portion of the food supply system 110 is one example of a coextruder that may be used in the invention. Other coextruders are also contemplated by the invention.

It is also contemplated that alternative food supply systems to the system 110 shown in FIG. 1 and described herein may be used in the invention. The purpose of such a system is to allow two food supplies to be supplied separately and coextruded into a continuous substantially linear stream of coextrudate, and preferably with an outer layer of the first supply completely surrounding a substantially continuous inner layer of the second supply.

The substantially linear stream of coextrudate produced by the food supply system 110 is then preferably moved along a conveyor 121 horizontally. Preferably, the stream of first and second food supplies maintains its construction and dimensions before being cut into individual food products, or patties.

Next, in the system 100 is a cutting system 120. The substantially linear stream of coextrudate supplied by the food supply system 120 is provided to the cutting system 120 by preferably moving along the conveyor 121 or is alternatively moved by some other applicable means. Using the conveyor 121 comprising a belt and roller (not shown), is preferable because it beneficially allows the coextrudate to generally maintain its desired construction and dimensions and not become substantially misshapen during movement.

The cutting system 120 comprises a cutting element 122 and a motor 123 that moves the cutting element 122. Preferably, the cutting element 122 comprises a rotatable blade with at least two cutting surfaces or blades. Preferably, the motor 123 rotates the cutting element 122 at a desired rate in order to coincide with the rate of coextrusion, such that the resulting individually cut food products or patties have a predetermined size and weight. The coextrudate is preferably advanced between individual blades on the cutting element 122 as it rotates. The cutting element then periodically cuts through the coextrudate. The timing and orientation of the rotation of the cutting element 122 preferably results in individually cut pieces of coextrudate of a desired size, weight and shape.

Other types of cutting elements are also contemplated by the invention. Another exemplary cutting system 120 may include a guillotine-type blade portion that is moved up and down by a motor (not shown). Other examples of cutting elements include, but are not limited to, wires, lasers, knives, water jets, blades, air, and other means for cutting.

Next, in the system 100, a flattening system 130 is shown. Although preferred, the flattening system is not required in the invention. It is possible that the individual co-extruded food products, after being cut, may not need to be shaped or otherwise manipulated further.

If flattening is desired, however, a preferred flattening system, as shown, comprises a first conveyor 131 and a second conveyor 132. The first and second conveyors 131, 132 are preferably opposing and spaced apart from each other at an angle to provide a wider gap end at or near the cutting system end 133 of the conveyors and a narrower gap end at the other end 134 of the set of conveyors 131, 132. The first conveyor 131 is preferably in close proximity to the cutting system 120. The purpose of the first conveyor 131 is to receive the cut food products and to advance them away from the cutting system 120. The second conveyor 132 is preferably angled with respect to the first conveyor 131 such that the two conveyors 131, 132 converge toward each other at the narrower gap end 134, for the purpose of progressively flattening food products as they move along and between the conveyors 131, 132. The purpose of flattening the individual co-extruded food products is to, preferably, provide the desired dimensions and shape for packaging. Other aesthetic reasons for flattening the food products in such a way also exist, with one example being that the food products may be desired to have the consistency of a meat patty made by hand. The flattening system 130 may preferably provide such a consistency.

The conveyors 131, 132 may each comprise a conveyor belt 135, 136, respectively, and a plurality of rollers 137. There will also be provided some means for moving the rollers 137, and/or the belts 135, 136. Other alternative means for conveying and flattening the food products, or patties, are, however, also contemplated by the invention.

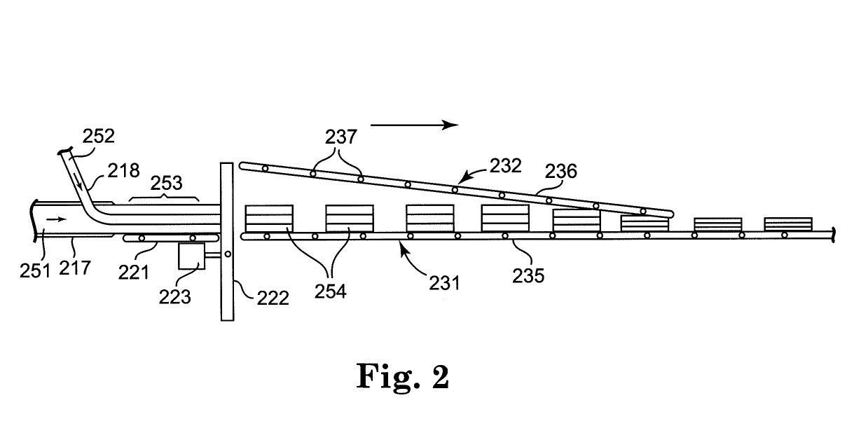

FIG. 2 is a cross-sectional illustration and close-up view of a portion of a system in accordance with the invention, and shown with first and second extrudable food supplies, coextrudate, and resultant individually cut food products. The figure shows a first supply tube 217 with a second supply tube 218 extending into about the middle of the first supply tube 217. A supply of meat 251, for example, is shown with the direction of travel indicated by the arrow. A supply of cheese 252, for example, is also shown with an arrow indicating the direction of travel. A continuous substantially linear coextruded stream of meat and cheese 253 is shown, prior to being cut. A rotating blade portion 222, as operated by a motor 223, may cut the stream of coextrudate 253 at periodic intervals, resulting in the individual food products, or patties, 254 of a desired size, weight and shape. As shown in the Figure, as the food products (in cross-section) are conveyed down the conveyor 231, they are flattened to a pre-determined dimension. Again, the flattening of the individual food products is an optional step and is not required in the invention. The direction of travel through the system shown in FIG. 2 is indicated by the arrow.

After the food products, or patties, 254 are conveyed and optionally flattened, the food products are preferably conveyed to a cooling system 140 (referring back to FIG. 1). The cooling step is also optional in the invention. The individual food products may be subsequently packaged fresh and without first cooling or freezing the food products.

As shown, the cooling system 140 may comprise a freezer or other cooling unit. Although not shown in FIG. 1, one or more conveyors may be used to move the food products through the cooling system 140. The purpose of the cooling system 140 is to at least partially solidify the individual food products prior to packaging. One reason for wanting the patties to be more solid is to help them maintain their size and shape during further processing or packaging, so the patties do not become misshapen.

After exiting the cooling system 140, the food products may then be further processed in a packaging system (not shown), for example. A conveyor 150 may preferably move the food products along to be packaged. One step in packaging could be interleaving the individual food products, or patties, with paper. Other steps could include delivering the food products, or patties, to a container and sealing the container. Other further processing or packaging steps are also contemplated by the invention, however.

Some examples of additional systems that may be included in the overall system 100, but are not shown, are hydraulic actuating systems, electrical actuating systems, and control systems, for examples. The invention contemplates the inclusion of additional systems or structures as desired or necessary.

A second aspect of the invention is a method of making individual co-extruded food products in a continuous process. One step in the method is providing two supplies of extrudable food product, such as meat and cheese, for example. The next step is to continuously horizontally co-extrude the supplies at a predetermined extrusion rate. The co-extrudate preferably includes a first layer that substantially surrounds a second layer, with the second layer, or filling, being substantially continuous. A substantially linear stream of coextrudate is formed. The liner stream is cut into individual co-extruded food products (e.g., cheese-filled meat products). The timing of the cutting is synchronized with the extrusion rate to provide individual co-extruded food products having an approximately predetermined size and weight. The cut may be made by a rotatable blade portion or a guillotine-type blade portion, for examples. The cut is preferably approximately transverse to the linear stream of coextrudate. The cut preferably exposes the filing layer in the resultant individual food product.

The method may further comprise a step of flattening the individual co-extruded food products after the cutting step. The flattening step may comprise advancing the individual co-extruded food products between a first and a second conveyor converging toward each other to define a gap between them tapering from a wider gap end to a narrower gap end for progressively flattening individual co-extruded food products.

The method may further comprise a step of cooling the individual co-extruded food products after the cutting step or after the flattening step, for examples. The method may further comprise a step of packaging the individual co-extruded food products after the cutting step, flattening or cooling steps.

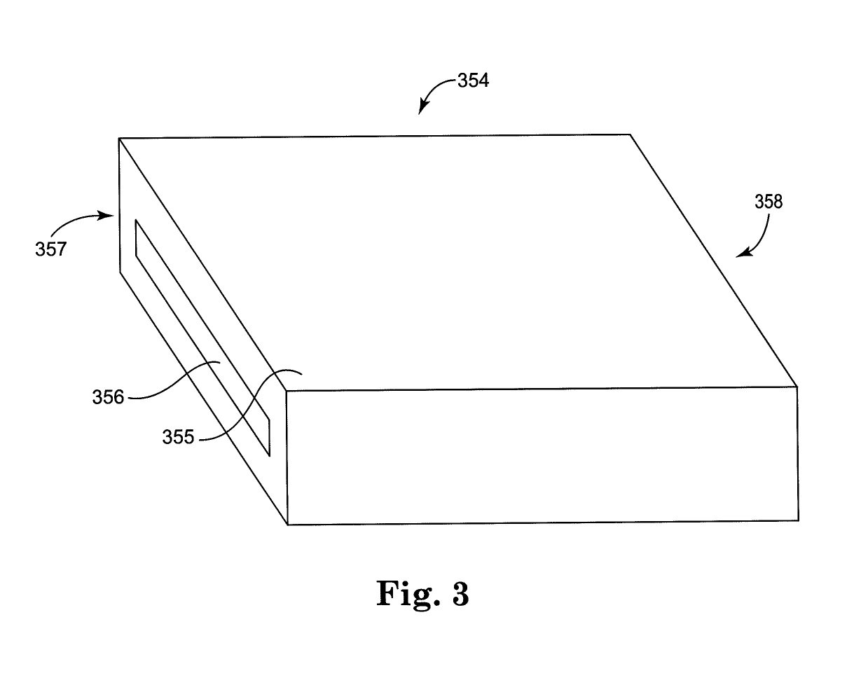

Food products, or patties, that are produced using the herein described system and method are a third aspect of the invention. FIG. 3 illustrates an example of such a food product, or patty 354. The patty 354 is a portion cut from a continuous web of coextrudate produced using the system and method described above. The patty 354 comprises a substantially continuous outer web or layer of first food supply 355 (e.g., meat) substantially surrounding a substantially continuous inner web or layer of second food supply 356 (e.g., cheese). Because of the methods and systems, as described above, that are employed to form the patty 354, the second food supply layer 356 is preferably exposed on the two cut ends 357, 358 of the patty 354.

The dimensions and shape of the food product, or patty 354, may depend upon the speed and orientation of the cutting system as well as the rate of production and movement of the coextrudate web through the system. Preferably, the shape of the patty 354 is square or rectangular, however other shapes are also contemplated. The square and rectangular dimensions may range from having lengths of about 2 to 5 inches and widths of about 2 inches to about 5 inches, but other sizes are also contemplated. The weight of the food product, or patty 354, may be controlled depending upon the rate of the cutting system, as well as the rate of production and movement of the coextrudate web through the system.

First extrudable food supply that may be used in accordance with the invention may be any variety of meat from any species. The meat is preferably ground or otherwise prepared to be extrudable. Suitable meats include those obtained from bovine, porcine, equine, caprine, ovine, avian animals, or any animal commonly slaughtered for food production. Bovine animals may include, but are not limited to, buffalo, and all cattle, including steers, heifers, cows, and bulls. Porcine animals may include, but are not limited to, feeder pigs and breeding pigs, including sows, gilts, barrows, and boars. Ovine animals may include, but are not limited to, sheep, including ewes, rams, wethers, and lambs. Poultry may include, but are not limited to, chicken, turkey, and ostrich. Other food supplies are contemplated, however.

Any suitable filler material or second food supply that may be co-extruded may be used in accordance with the invention. The filler material may comprise any suitable filling material, such as, e.g., a sauce, a cheese, a meat slurry, a fruit filling, etc. Any suitable filler material is contemplated by the invention, and is not limited to those provided herein.

A cheese that may be used as a filler in accordance with the invention preferably may be any variety that is pumpable at cool temperatures necessary for safe storage and production of a refrigerated food product (e.g., at or below about 40 degrees F.). Additionally, the cheese preferably has a viscosity and a high melting point such that when cooking the food product on the grill or stove, etc., the cheese layer does not melt, flow or ooze out of the food product. Preferably, the cheese does not flow at a temperature of about 180 degrees F.

Optionally, the materials that are co-extruded, e.g., meat and cheese, may be kept at a sufficiently low temperature that is below about 50 degrees F., more preferably below about 45 degrees F., through the entire process. Therefore, one embodiment of the invention may include all portions of the system being cooled to such a sufficiently low temperature.

It is contemplated that the invention may be used to form food products that are made of other ingredients besides meat and cheese.

The foregoing detailed description has been given for clarity of understanding only. No unnecessary limitations are to be understood therefrom. The invention is not limited to the exact details shown and described, for variations obvious to one skilled in the art will be included within the invention as defined by the claims.

1. A system for continuously making individual co-extruded food products comprising:
a food supply system comprising a first extrudable food supply and a second extrudable food supply that are horizontally co-extruded at a predetermined extrusion rate into a substantially linear stream of coextrudate comprising a substantially continuous layer of the first extrudable food supply surrounding a substantially continuous layer of the second extrudable food supply; and
a cutting system, comprising a cutting element for cutting the stream of coextrudate supplied by the food supply system, wherein the timing of movement of the cutting element is synchronized with the extrusion rate to provide individual co-extruded food products having an approximately predetermined size and weight.

2. A system of claim 1 for continuously making individual co-extruded food products comprising:
a means for supplying a first extrudable food supply and a second extrudable food supply;
a means for horizontally co-extruding the first and second supplies at a predetermined extrusion rate into a substantially linear stream of coextrudate comprising a substantially continuous layer of the first food supply surrounding a substantially continuous layer of the second food supply; and
a means for cutting the stream of coextrudate supplied by the food supply system, wherein the timing of movement of the cutting means is synchronized with the extrusion rate to provide individual co-extruded food products having an approximately predetermined size and weight.

3. A method of making individual co-extruded food products in a continuous process comprising the steps of:
providing a first extrudable supply of food and a second extrudable supply of food;
continuously horizontally co-extruding the supplies of food at a predetermined extrusion rate wherein the first supply is substantially continuous and substantially surrounds the second supply that is substantially continuous, such that a substantially linear stream of coextrudate is formed; and
cutting the stream of coextrudate into individual co-extruded food products wherein the timing of the cutting is synchronized with the extrusion rate to provide individual co-extruded food products having an approximately predetermined size and weight.

4. The system of claim 1, further comprising a flattening system adjacent the cutting system for advancing and flattening the individual co-extruded food products.

5. The system of claim 1, further comprising a cooling system or cooling step.

6. The system of claim 1, wherein the cutting element includes a rotatable blade comprising at least one cutting surface for cutting the stream of coextrudate.

7. The system of claim 1, wherein the cutting element includes a guillotine-type blade.

8. The system of claim 1, wherein the first extrudable food supply comprises a meat.

9. The system of claim 1, wherein the second extrudable food supply comprises a material selected from the group consisting of a cheese, a sauce, a meat slurry, and a fruit filling.

10. The system of claim 9, wherein the second extrudable food supply is pumpable at a temperature necessary for safe storage and production of refrigerated food products.

11. The system of claim 9, wherein the second extrudable food supply has a viscosity and a melting point such that when cooking the food products, the second extrudable food supply layer is not flowable.

12. A co-extruded food product made by the method of claim 3.

13. A co-extruded food product cut from a substantially continuous linear stream of coextrudate, the food product comprising:
a substantially continuous layer of a first food product; and
a layer of a second food product that at least partially surrounds the layer of the first food product;
wherein the co-extruded food product is cut transverse to the linear stream of coextrudate such that the layer of the first food product is exposed on opposing ends.

14. The co-extruded food product of claim 13, wherein the second layer surrounds the first layer except at or near where the coextrudate is cut.

15. The co-extruded food product of claim 13, wherein the first layer material is pumpable at a temperature necessary for safe storage and production of refrigerated food products.

16. The method of claim 3, further comprising a step for advancing and flattening the individual co-extruded food products.

17. The method of claim 3, further comprising a cooling step.

18. The method of claim 3, wherein the cutting step includes use of a rotatable blade comprising at least one cutting surface for cutting the stream of coextrudate.

19. The method of claim 3, wherein the cutting step includes use of a guillotine-type blade.

20. The method of claim 3, wherein the second extrudable food supply comprises a material selected from the group consisting of a cheese, a sauce, a meat slurry, and a fruit filling, wherein the second extrudable food supply has a viscosity and a melting point such that when cooking the food products, the second extrudable food supply layer is not flowable.
